(19) United States
(12) Patent Application Publication
(10) Pub. No.: US 2005/0225758 A1
(43) Pub. Date: Oct. 13, 2005

(54) Raman optical identification tag

(76) Inventors: Kevin J. Knopp, Newburyport, MA (US); Daryoosh Vakhshoori, Cambridge, MA (US); Gregory Vander Rhodes, Melrose, MA (US)

Correspondence Address: Pandiscio & Pandiscio, 470 Totten Pond Road, Waltham, MA, 02451-1914, US

(21) Appl. No.: 11/088,169

(22) Filed: Mar. 23, 2005

Related U.S. Application Data
(60) Provisional application No. 60/555,423, filed on Mar. 23, 2004.

(51) Int. Cl. G01J 3/44; G01N 21/65

(52) U.S. Cl. 356/301

(57) ABSTRACT

A method for tagging and identifying a composition using Raman spectroscopy is disclosed, the method comprising tagging the composition by disbursing additional individual tag molecules throughout a base material thereof so as to create a tagged material having a spectral profile with a specific Raman optical signature encoded therein, wherein the specific Raman optical signature of the tagged material is distinct from the native Raman optical signature of the base material; and identifying the composition by reading a spectral response of the tagged material with a Raman spectroscopic technique so as to identify the composition based on the specific Raman optical signature encoded in the tagged material rather than the native Raman optical signature encoded in the base material.

### REFERENCE TO PENDING PRIOR PATENT APPLICATION

This patent application claims benefit of pending prior U.S. Provisional Patent Application Ser. No. 60/555,423, filed Mar. 23, 2004 by Kevin J. Knopp et al. for RAMAN OPTICAL IDENTIFICATION(RO-ID) TAG (Attorney's Docket No. AHURA-21 PROV), which patent application is hereby incorporated herein by reference.

### FIELD OF THE INVENTION

This invention relates to Raman spectroscopy apparatus and methods in general, and more particularly to apparatus and methods for tagging and identifying materials using Raman spectroscopy.

### BACKGROUND OF THE INVENTION

Light incident on a molecule is scattered. Most of the photons are “elastically scattered” and thus have the same energy and wavelength as the photons of the incident light. A small fraction of light is scattered to one or more lower optical frequencies than the frequency of the incident photons. This process of “inelastic scatter” is commonly termed the Raman effect.

Raman scattering can occur with a change in the vibrational energy of a molecule. The difference in energy between the incident photon and the Raman scattered photon is equal to the energy of a vibration of the scattering molecule. The Raman spectrum of a material is a plot of the intensity of scattered light versus energy difference. This Raman spectrum serves as a chemical fingerprint of the material being illuminated. This fingerprint uniquely identifies a material by the specific blend of various scattering molecules present in the material.

Looking at FIG. 1, there is shown an example of a Raman spectrum 5 for aspirin (i.e., acetylsalicylic acid).

The Raman spectrum of a material can be used to identify various types of materials such as solids, liquids, and powders. This identification is currently being used for classification and identification of unknown substances found by hazardous material teams, first responders, drug enforcement agents, forensic scientists, etc.

### SUMMARY OF THE INVENTION

An object of the present invention is to provide a method for tagging and identifying a material using Raman spectroscopy.

Another object of the present invention is to provide a method for tagging an entire batch of material and identifying a portion thereof which may become intentionally or unintentionally separated from or broken away from the remainder of the material.

A further object of the present invention is to provide a composition comprising a base material having additional individual tag molecules disbursed throughout the base material so as to allow identification of the composition using the specific Raman optical signature of the base material together with the additional molecules.

With the above and other objects in view, as will hereinafter appear, there is provided a method for tagging and identifying a composition using Raman spectroscopy, the method comprising:
tagging the composition by disbursing additional individual tag molecules throughout a base material thereof so as to create a tagged material having a spectral profile with a specific Raman optical signature encoded therein, wherein the specific Raman optical signature of the tagged material is distinct from the native Raman optical signature of the base material; and
identifying the composition by reading a spectral response of the tagged material with a Raman spectroscopic technique so as to identify the composition based on the specific Raman optical signature encoded in the tagged material rather than the native Raman optical signature encoded in the base material.

In accordance with a further feature of the invention, there is provided a composition having a base material with a native Raman optical signature encoded therein, the composition comprising additional individual tag molecules disbursed throughout the base material thereof, wherein the additional tag molecules within the base material create a tagged material having a specific Raman optical signature encoded therein, and wherein the specific Raman optical signature of the tagged material is distinct from the native Raman optical signature of the base material so as to allow identification of the composition using the specific Raman optical signature of the tagged material.

In accordance with a further feature of the invention, there is provided a method for tagging and identifying a composition using Raman spectroscopy, the method comprising:
providing a base material having a first Raman optical signature associated therewith, and providing a tag material having a second Raman optical signature associated therewith;
dispersing the tag material throughout the base material so that the individual molecules of the tag material are interspersed with the molecules of the base material on a molecular level, whereby to form the composition, with the composition having a third Raman optical signature associated therewith, wherein the third Raman optical signature is a composite of the first Raman optical signature and the second Raman optical signature;
identifying the composition by reading the third Raman optical signature of the composition and identifying the second Raman optical signature associated with the tag material so as to determine the tag material in the composition, whereby to identify the composition.

In accordance with a further feature of the invention, there is provided a composition comprising:
a base material having a first Raman optical signature associated therewith; and
a tag material having a second Raman optical signature associated therewith;
the tag material being dispersed throughout the base material so that the individual molecules of the tag material are interspersed with the molecules of the base material on a molecular level, whereby to form the composition, with the composition having a third Raman optical signature associated therewith, wherein the third Raman optical signature is a composite of the first Raman optical signature and the second Raman optical signature;
wherein the first Raman optical signature of the base material is distinct from the second Raman optical signature of the tag material so as to allow identification of the composition using the second Raman optical signature of the tag material.

The above and other features of the invention will now be more particularly described with reference to the accompanying drawings and pointed out in the claims. It will be understood that the particular devices and method steps embodying the invention are shown by way of illustration only and not as limitations of the invention. The principles and features of this invention may be employed in various and numerous embodiments without departing from the scope of the invention.

### BRIEF DESCRIPTION OF THE DRAWINGS

These and other objects and features of the present invention will be more fully disclosed or rendered obvious by the following detailed description of the preferred embodiments of the invention, which are to be considered together with the accompanying drawings wherein like numbers refer to like parts, and further wherein:

FIG. 1 is a diagrammatic illustration of the Raman spectrum for aspirin;

FIG. 2 is a diagrammatic illustration of the Raman spectrum for titanium dioxide;

FIG. 3 is a diagrammatic illustration of the Raman spectrum for talc;

FIG. 4 is a schematic diagram showing the base material and four different tags and the spectral signatures associated with each;

FIG. 5 is a schematic diagram showing the Raman spectra for (i) a base material, (ii) a first tag, (iii) a second tag, and (iv) a composition consisting of the base material, the first tag and the second tag; and

FIG. 6 illustrates how the relative intensities of the additional tag molecules may be assessed so as to implement “gray-scale” detection.

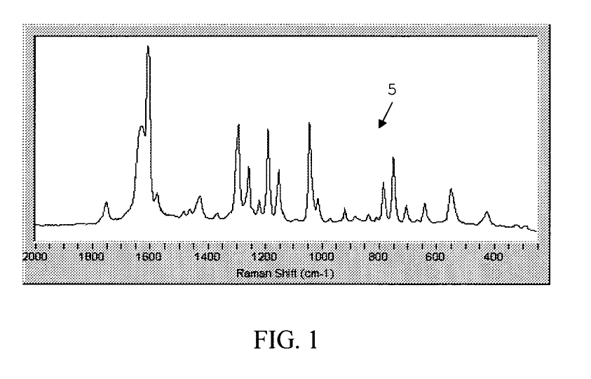

### DETAILED DESCRIPTION OF THE PREFERRED EMBODIMENTS

### Overview

The present invention provides methods and compositions of matter for tagging bulk items and bulk materials for the purpose of identification and tracking. In a preferred embodiment of the present invention, a specific Raman optical signature is encoded into an item or material in addition to its native Raman spectrum. Preferably, this encoded signature is read at a later time using standard Raman spectroscopic techniques. The encoded signature is dispersed on a molecular level within and throughout the entirety of the material itself rather than simply residing as a mark on a portion of the item. Thus, the present invention provides methods and compositions of matter which are ideal for tagging bulk items and materials which may become intentionally or unintentionally separated from or broken away from the remainder of the material at a later time, as each fraction of the original item or material contains the same encoded signature. The present invention provides methods and compositions of matter which are ideal for items or materials in which the attachment a physical tag is inconvenient or impractical.

### Technology

In a preferred embodiment of the present invention, there is provided a method in which additional Raman scattering peaks are superimposed into the Raman spectrum of the native material through the introduction of additional individual tag molecules interspersed, on a molecular level, throughout the base bulk material during its manufacture. These additional molecules of one or more substances create a tagged material for the purpose of encoding manufacturing and other traceability information. The Raman spectral profile of the tagged material is obtained in the field so as to determine the encoded information therein, which in turn relates to the manufacturing and other traceability information. Preferably, traditional Raman spectroscopy techniques are used to excite and detect both the Raman spectrum of the base material and the Raman spectrum of the added molecules superimposed on the Raman spectrum of the base material, which together encode the manufacturing identification tag. These techniques include, but are not limited to, spontaneous Raman spectroscopy, stimulated Raman spectroscopy, Raman difference spectroscopy, surface enhanced Raman spectroscopy, etc.

The specific types of additional molecules chosen for disbursement throughout the base material for encoding purposes depend on the nature of the base material. In many cases, it is desirable to use additional tag molecules having similar characteristics to those of the base material so as to ensure minimal modification of the physical properties of the base materials.

It is often desirable to use materials for the additional molecules which have regulatory approval for distribution, and perhaps consumption, if applicable, in the desired industry of the product.

As an example, approved food colorings or other excipients (i.e., inactive ingredients) are often desirable for products in the food and agriculture market sector. For pharmaceutical drugs, which generally consist of an active pharmaceutical ingredient (API) and excipients, it is generally desirable to also add approved inactive ingredients which are known not to alter the efficacy of the API.

Examples of such excipient ingredients may include, but are not limited to, beeswax, benzyl alcohol, calcium stearate, calcium sulfate, carbowax, carob, cellulose methyl, cellulose microcrystalline, cellulose powdered, crosscarmellose sodium, dicalcium phosphate, FD&C Yellow No. 6, FD&C Red No. 40, silicon dioxide, fructose, gelatin, glycerin, glyceryl monostearate, glyceryl triacetate, hydroxypropyl methylcellulose phthalate (HPMCP), maltol (natural), polyethylene glycol, polyvinylpyrrolidone, potassium sorbate, povidone, phthalate, shellac (purified), silica, talc, sodium benzoate, sorbitan mono-oleate, titanium dioxide, triacetin, xanthan gum, etc.

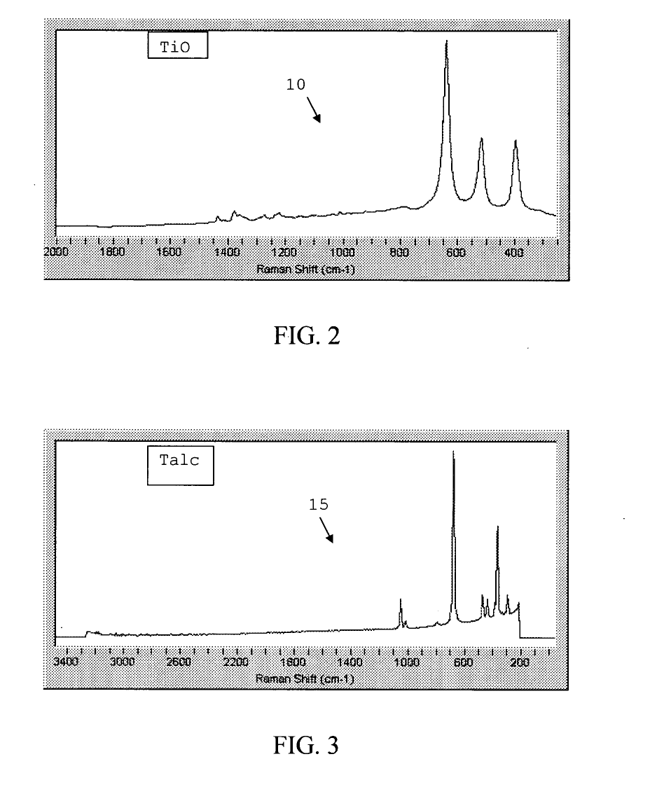

Referring to FIGS. 2 and 3, and as an example, there is shown a Raman spectrum 10 for titantium dioxide and a Raman spectrum 15 for talc. In this case, the excipients of titanium dioxide and talc have spectra features in a region generally removed from that of a base material of aspirin. Thus, where a composition comprises aspirin and a tag of titanium dioxide and/or talc, it will be relatively easy to detect the tag using Raman spectroscopy techniques.

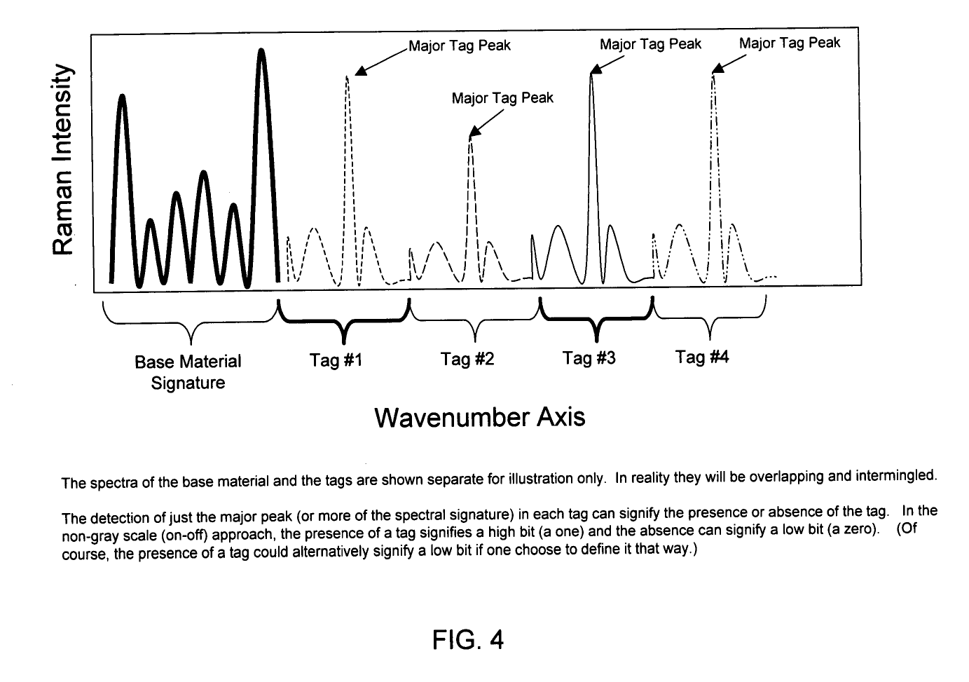

FIG. 4 is a schematic diagram showing the base material and four different tags and the spectral signatures associated with each.

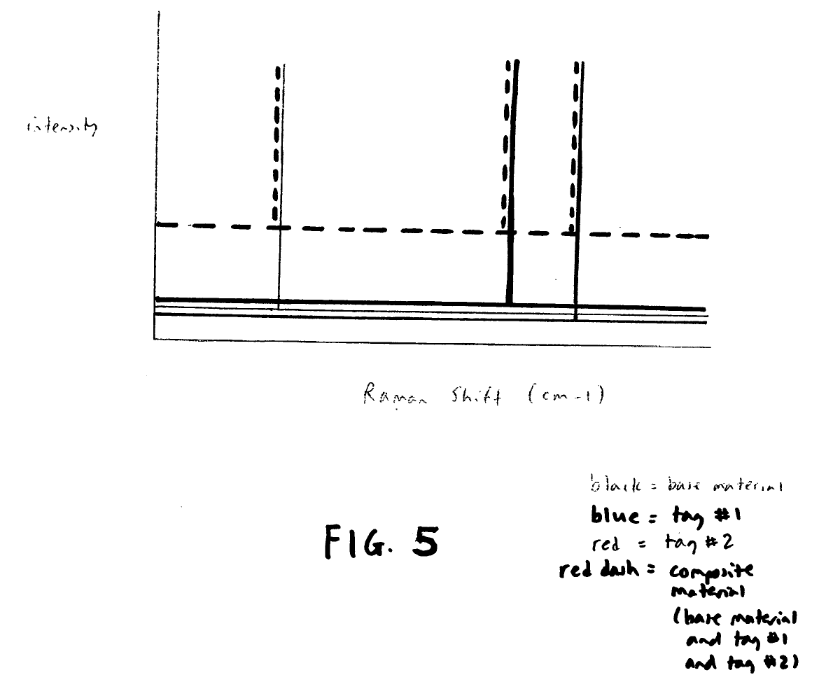

FIG. 5 is a schematic diagram showing the Raman spectra for (i) a base material, (ii) a first tag, (iii) a second tag, and (iv) a composition consisting of the base material, the first tag and the second tag. As is apparent from the schematic diagram of FIG. 4, selecting tag molecules having spectra features generally removed from that of a base material facilitates detection of the tag using Raman spectroscopy techniques.

### Information Encoding

The composition, number, and type of additional tag molecules included to encode the identification tag throughout the material during manufacture determine the amount of information which can be encoded. Constraints may be imposed by the method chosen for reading the Raman spectra. The signal-to-noise of the measurement technique limits the minimum concentration of the additional tag molecules within the base material such that the Raman spectrum of the additional molecules can be read. Detection levels of less than 1 ppm have been demonstrated.

For a given type of additional tag molecule interspersed within the base material, information can be encoded by simply detecting the presence of the additional tag molecule in the base material, preferably represented by the binary digit 1, or the absence of the additional tag molecule in the base material, preferably represented by the binary digit 0. This most simple form of encoding gives 1 bit per N types of tag molecule added to the base material. N types of tag molecules added to the base material yield 2^{N} bits of tagging data which is stored throughout the base material, interspersed on a molecular level, as an identification tag.

As this configuration can be limiting in some situations, it is generally desirable to allow “gray-scale” detection of the concentration of the added tag molecules by analyzing the intensity of the Raman peaks of the added tag molecules. In a preferred embodiment of the present invention, greater than 12 bits of intensity is achieved for each tag molecule type. This allows

$$\sqrt[2]{{12}^{N}}$$

bits of data, which assumes 12 bits of intensity resolution and N molecules. For best performance, it is generally desirable to reference the measured intensities to the peak strengths of the base material during read out.

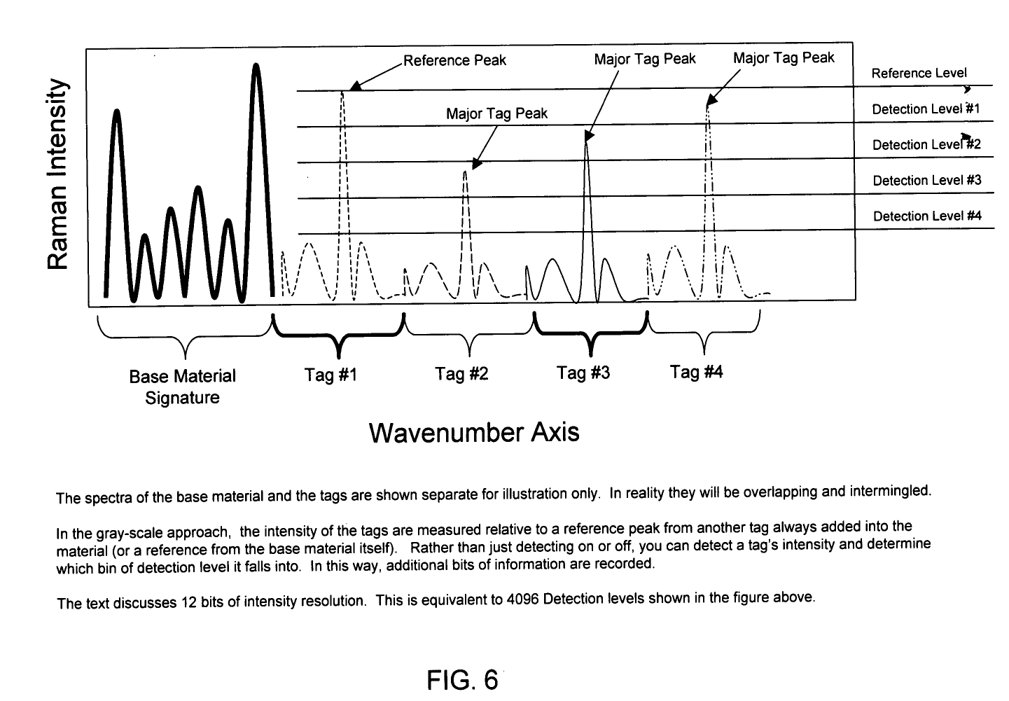

FIG. 6 illustrates how the relative intensities of the additional tag molecules may be assessed so as to implement “gray-scale” detection.

The encoded data of a bulk identification tag alone does not need to be unique across all industries. It should be appreciated that the encoded data of the tagged material is formed by the specific Raman signature of the added tag molecules together with the native Raman signature of the base material. Accordingly, the Raman signature of the base material serves as an additional bit of encoded data.

### Applications

The tagging methods and material compositions of the present invention are useful for applications spanning many industries. These tagging methods and material compositions for encoding and reading are useful in connection with liquids, solids and even gases. These tagging methods and material compositions are useful to encode such things as lot or batch information, expiration date, manufacturing date, manufacturing plant information, an identification number, product make, model number, revision number, a vehicle identification number (VIN), serial number, point of origin, etc. Such information can be used for such things as product recalls, production information/research, marketing information, forensic investigations, consumer safety, security, etc.

One use of the present invention includes encoding orange juice with the manufacture and lot information so as to allow tracking in the event of product tampering. If a consumer consumes the juice and later becomes ill, a test can be performed on the consumed undigested juice to track back to the lot and manufacture.

Another use of the present invention includes encoding ground beef to allow tracking to the retail outlet if a cow is later diagnosed with an infectious disease.

Another use of the present invention includes encoding automotive components. In the event of a hit-and-run automobile accident, plastic shards left at the crime scene from the auto bumper, headlights, or other car panels will contain identifying information such as the make and model of the vehicle, or even the VIN number.

Another use of the present invention includes encoding pharmaceutical drugs such as pills, creams, lotions, medications, etc. The present invention allows these pharmaceutical drugs to be labeled within the product itself, on a molecular level, rather than simply on the container of the product.

It will be appreciated that still further embodiments of the present invention will be apparent to those skilled in the art in view of the present disclosure. It is to be understood that the present invention is by no means limited to the particular constructions herein disclosed and/or shown in the drawings, but also comprises any modifications or equivalents within the scope of the invention.

1. A method for tagging and identifying a composition using Raman spectroscopy, the method comprising:
tagging the composition by disbursing additional individual tag molecules throughout a base material thereof so as to create a tagged material having a spectral profile with a specific Raman optical signature encoded therein, wherein the specific Raman optical signature of the tagged material is distinct from the native Raman optical signature of the base material; and
identifying the composition by reading a spectral response of the tagged material with a Raman spectroscopic technique so as to identify the composition based on the specific Raman optical signature encoded in the tagged material rather than the native Raman optical signature encoded in the base material.

2. A method according to claim 1 wherein the additional tag molecules are selected to minimize modifications to properties of the base material of the composition.

3. A method according to claim 2 wherein the additional tag molecules comprise an approved food coloring.

4. A method according to claim 3 wherein the base material is a food.

5. A method according to claim 2 wherein the additional tag molecules comprise an excipient.

6. A method according to claim 5 wherein the base material comprises a pharmaceutical drug having an active pharmaceutical ingredient, and wherein the additional tag molecules comprise an excipient configured to leave the active pharmaceutical ingredient unaffected.

7. A method according to claim 1 wherein at least a portion of the specific Raman optical signature of the additional tag molecules is disposed in a first region of the Raman spectrum of the tagged material, at least a portion of the native Raman optical signature of the base material is disposed in a second region of the Raman spectrum of the tagged material, and the first region and the second region are separate from one another.

8. A method according to claim 1 wherein the specific Raman optical signature of the additional tag molecules is disposed in a first region of a Raman spectrum of the tagged material, the native Raman optical signature of the tagged material is disposed in a second region of the Raman spectrum of the base material, and the first region and the second region overlap one another.

9. A method according to claim 1 wherein the additional tag molecules comprise a quantity of less than 1 part per million of the item.

10. A method according to claim 1 wherein the specific Raman optical signature of the additional tag molecules is identified by detecting and analyzing the locations of Raman peaks of the specific Raman optical signature of the additional tag molecules.

11. A method according to claim 10 wherein the presence or absence of the peaks signifies one bit of information per peak.

12. A method according to claim 10 wherein the specific Raman optical signature of the additional tag molecules is identified by detecting and analyzing the relative intensities of the Raman peaks of the specific Raman optical signature of the additional tag molecules.

13. A method according to claim 12 wherein the relative intensities of the Raman peaks reflect the relative proportions of the tag molecules.

14. A method according to claim 13 wherein the relative intensities of the Raman peaks are viewed in the context of intensity strata so as to encode additional bits of information.

15. A method according to claim 12 wherein the relative intensities of the Raman peaks of the additional tag molecules are referenced against native Raman peak intensities of the base material.

16. A method according to claim 12 wherein the relative intensities of the Raman peaks of the additional tag molecules are referenced against known concentrations of the additional tag molecules.

17. A method according to claim 1 further comprising the step of:
recording the encoded signature of the tagged material with a Raman spectroscopic technique subsequent to the step of tagging the composition, and wherein the step of identifying the composition by reading the encoded signature of the tagged material with the Raman spectroscopic technique comprises matching (i) the spectral response of the encoded signature of the tagged material as read, and (ii) the spectral profile of the encoded signature of the tagged material as previously recorded.

18. A method according to claim 17 wherein the encoded signature of the tagged material is stored in a computer database, and the spectral response of the encoded signature of the tagged material is compared to the computer database so as to identify the spectral profile of the encoded signature of the composition as previously stored.

19. A composition having a base material with a native Raman optical signature encoded therein, the composition comprising additional individual tag molecules disbursed throughout the base material thereof, wherein the additional tag molecules within the base material create a tagged material having a specific Raman optical signature encoded therein, and wherein the specific Raman optical signature of the tagged material is distinct from the native Raman optical signature of the base material so as to allow identification of the composition using the specific Raman optical signature of the tagged material.

20. A composition according to claim 19 wherein the base material comprises one selected from the group consisting of a solid material, a liquid material, and a gaseous material.

21. A composition according to claim 20 wherein the base material comprises a granulated material.

22. A method for tagging and identifying a composition using Raman spectroscopy, the method comprising:
providing a base material having a first Raman optical signature associated therewith, and providing a tag material having a second Raman optical signature associated therewith;
dispersing the tag material throughout the base material so that the individual molecules of the tag material are interspersed with the molecules of the base material on a molecular level, whereby to form the composition, with the composition having a third Raman optical signature associated therewith, wherein the third Raman optical signature is a composite of the first Raman optical signature and the second Raman optical signature;
identifying the composition by reading the third Raman optical signature of the composition and identifying the second Raman optical signature associated with the tag material so as to determine the tag material in the composition, whereby to identify the composition.

23. A composition comprising:
a base material having a first Raman optical signature associated therewith; and
a tag material having a second Raman optical signature associated therewith;
the tag material being dispersed throughout the base material so that the individual molecules of the tag material are interspersed with the molecules of the base material on a molecular level, whereby to form the composition, with the composition having a third Raman optical signature associated therewith, wherein the third Raman optical signature is a composite of the first Raman optical signature and the second Raman optical signature;
wherein the first Raman optical signature of the base material is distinct from the second Raman optical signature of the tag material so as to allow identification of the composition using the second Raman optical signature of the tag material.
